(19) United States
(12) Patent Application Publication
(10) Pub. No.: US 2017/0361313 A1
(43) Pub. Date: Dec. 21, 2017

(54) Pipette block with molded piston chambers

(71) Applicant: Felix H. Yiu, Covina, CA (US)

(72) Inventor: Felix H. Yiu, Covina, CA (US)

(21) Appl. No.: 14/631,788

(22) Filed: Feb. 25, 2015

(51) Int. Cl. B01L 3/02; G01N 35/10

(52) U.S. Cl. CPC B01L 3/02; G01N 35/10; B01L 3/0213; B01L 3/022; B01L 2300/0829

(57) ABSTRACT

The present invention relates to a pipette dispensing block with an improved design for the piston chambers. In a multichannel pipetting block with a grid or array of pipetting piston of any order, the individual piston chambers are individually manufactured using the injection molding process. The individual piston chambers are assembled into a grid or single line array and held together by upper and lower plates in combination with either stabilizing posts or walls. The piston chambers are designed and assembled with a dual o-ring design at the tip and a tip sealing gasket at the bottom to provide the air-tight seal that is required for optimum pipetting performance. When combined with pistons and a motor-driven lifting plate for the pistons, the entire assembly forms a forms a multichannel pipetting block

### CROSS-REFERENCE TO RELATED APPLICATIONS

U.S. Pat. No. 6,258,324 Pipette dispensing block

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is used in the field of small volume liquid pipetting using the air displacement pipetting technique. These air displacement pipettors are used to pipette or aspirate and dispense (transfer) small volumes of liquid, a typical volume range being 1 microliter to 1 milliliter of liquid.

Air displacement pipettors can be constructed to pipette one liquid sample at a time, or more than one. Commonly available air displacement pipettors use a number of pistons within piston chambers that are connected to disposable tips arranged in a single line array, or arranged in a grid pattern. It is a standard in the industry to pipette to and from microtiter plates that have an industry-accepted spacing of liquid containers, or wells. These microtiter plates, also called microplates, commonly have 96 wells arranged in an 8×12 grid or 384 wells arranged in a 16×24 grid. The spacing between wells is defined by the industry-accepted standard. This allows multichannel air displacement pipettors to be constructed that are able to access multiple wells at once for pipetting, either in a single row or as a grid.

When constructing a multichannel pipettor, the prior art uses the common method of constructing a pipette block from a single piece of machined aluminum, steel, or other metal or rigid material. In order to accommodate the individual pistons for each pipetting channel, a piston chamber is constructed for each piston by precisely machining the chambers by drilling or other machining methods. For example, a pipette block designed for a typical 96-channel pipetting operation would require 96 individual pistons arranged in an 8×12 grid. This requires that the pipette block have 96 machined piston chambers that are not only precisely fitting to the pistons but are also precisely arranged in the grid pattern with uniform equidistant spacing. The manufacture of the machined pipette block is difficult, rigid and expensive because of the precision required to machine every channel, and is also difficult to troubleshoot and maintain.

The prior art methods of constructing pipetting blocks have a number of limitations.

One limitation of the prior art is that the manufacturing of the pipette block requires a high degree of precision machining and is difficult to accomplish.

Another limitation of the prior art is that the manufacturing of the pipette block is expensive to produce.

Yet another limitation of the prior art is that it is difficult to produce different layouts of pipetting channels, such a single line arrays with different numbers of channels or grid patterns with different layouts of horizontal and vertical channels. Each different head design requires a completely new single-piece pipette block to be designed and manufactured.

Yet another limitation of the prior art is that the single-piece pipette block is difficult to troubleshoot and maintain. If a single channel or some random channels within the head should become damaged, it is very difficult if not impossible to repair these, and they cannot be replaced.

The present invention is a novel design that addresses the shortcomings of the current art for the production of a pipette block, using individually-molded piston chambers that can be assembled together to form a pipette block.

### BRIEF SUMMARY OF THE PRESENT INVENTION

The present invention is a novel design that addresses the shortcomings of the current art when manufacturing a multichannel pipette dispensing block. The invention consists of a series of individual piston chambers that are manufactured using the injection molding process. The individual piston chambers are then arranged into any desired grid or single line array and attached together with a simple bracing structure. By eliminating the need for manufacturing a single machined one-piece pipette head block the shortcomings of the current art are eliminated.

It is an objective of the invention to manufacture individual and separate piston chambers for a multichannel pipette block.

It is another objective of the invention to create an assembly set of the individual piston chambers that can easily be used to create a grid or single line array of multiple channels to be used for multichannel pipetting.

It is yet another objective of the invention to reduce the complexity and cost of manufacturing a multichannel pipette dispensing block.

It is yet another objective of the present invention to produce a more precise piston chamber for multichannel pipetting in order to produce better precision results for pipetting.

It is yet another objective of the present invention to provide a simpler and more cost-effective way to build multichannel pipetting blocks in various configurations as needed for different pipetting applications.

It is yet another objective of the present invention to produce a multichannel pipette dispense block that is easier and more cost-effective to troubleshoot and repair.

These and other advantages and features of the present invention are described with specificity so as to make the present invention understandable to one of ordinary skill in the art.

### BRIEF DESCRIPTION OF SEVERAL VIEWS OF THE DRAWINGS

FIG. 1A is a side plan and cutaway view showing design of the prior art for a pipette dispense block in comparison to the current invention.

FIG. 1B shows the current invention for the design of the multichannel pipette dispense block.

FIG. 2 is a side plan and cutaway view and perspective view of one embodiment of the single molded piston chamber.

FIG. 3A is a side plan and cutaway view showing the assembly of individual and separate piston chambers combined together and attached in order to form a multichannel pipette dispense block.

FIG. 3B shows a close-up view of the upper assembly of the piston chambers of FIG. 3A.

FIG. 4. is a perspective view showing the assembly of individual and separate piston chambers combined together and attached in order to form a multichannel pipette dispense block.

FIG. 5 is a side plan and cutaway view and perspective view of a second embodiment of the single molded piston chamber.

FIG. 6 is side plan and cutaway view and perspective view of a third embodiment of the single molded piston chamber.

FIG. 7 is side plan and cutaway view and perspective view of the third embodiment of the single molded piston chamber.

FIG. 8 is side plan and cutaway view and perspective view of a fourth embodiment of the single molded piston chamber.

### DETAILED DESCRIPTION OF THE INVENTION

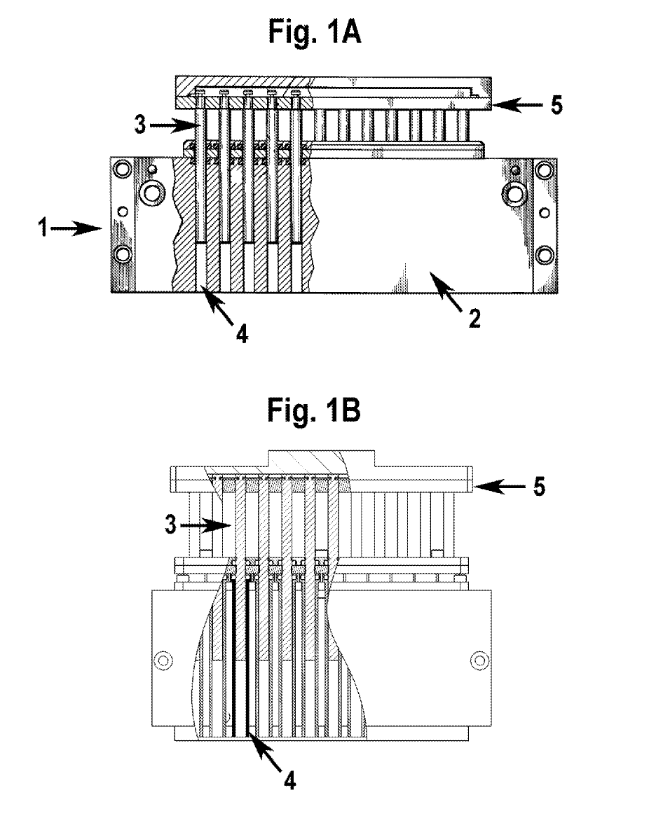

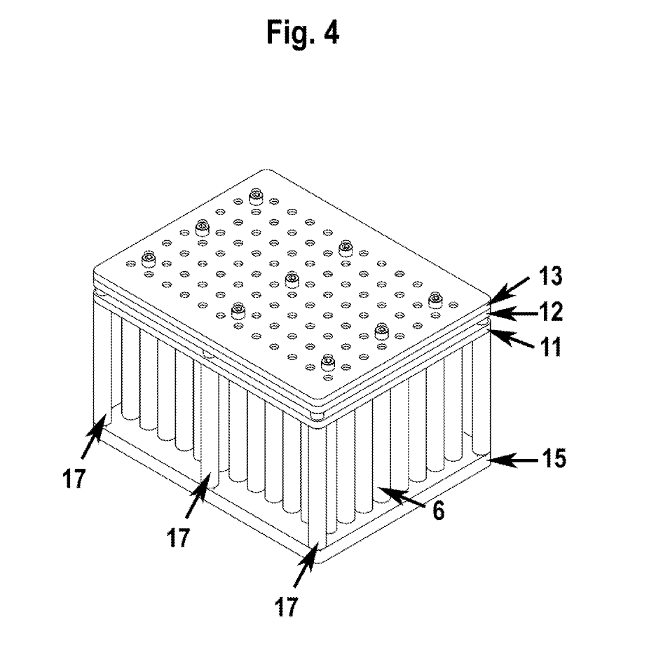

FIG. 1A is a cutaway side view of the prior art (U.S. Pat. No. 6,258,324) for a multichannel pipette dispense block 1. As is typical for the prior art, the pipette block consists of a metal block 2 with a plurality of machined piston chambers 4. The pistons 3 travel slidingly in the vertical direction through the piston chambers 4. The upper end of the pistons 3 are attached to a lift plate 5 which is used to move the pistons all together at once in the vertical direction. The lift plate 5 is attached to a motor or may be moved manually by a human operator (not shown). FIG. 1B shows the current invention for the design of the multichannel pipette dispense block. The same pistons 3 are used, which are precisely manufactured metal rods or tubes. The pistons 3 are attached to a lifting plate 5 to allow all of the pistons to move together in the vertical direction. The pistons 3 travel slidingly in the vertical direction within the piston chambers 4. In the current invention, there is no machined block at all. Instead, the individual piston chambers 4 are assembled together to form the grid or single line array of channels as described in FIG. 4.

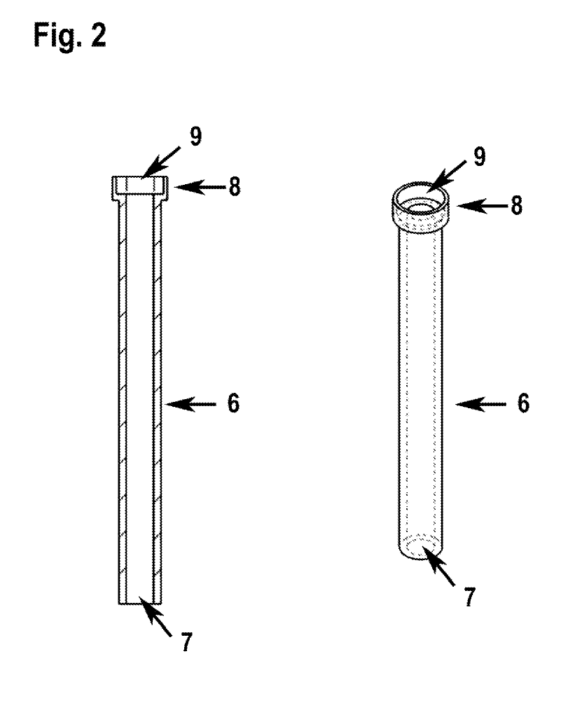

FIG. 2 shows a cutaway side view and perspective view of one embodiment of the current invention. The piston chamber 6 is a cylindrical shape which is formed by the injection molding process. The inside of the cylinder is hollow and is the piston chamber 7 within which the piston (not shown) would travel. The piston chamber has a larger diameter collar 8 at the top which provides a mounting point for the piston chamber. The collar 8 also provides a larger internal hollow space 9 at the top of the piston chamber which is used for the placement of a sealing 0-ring (not shown)

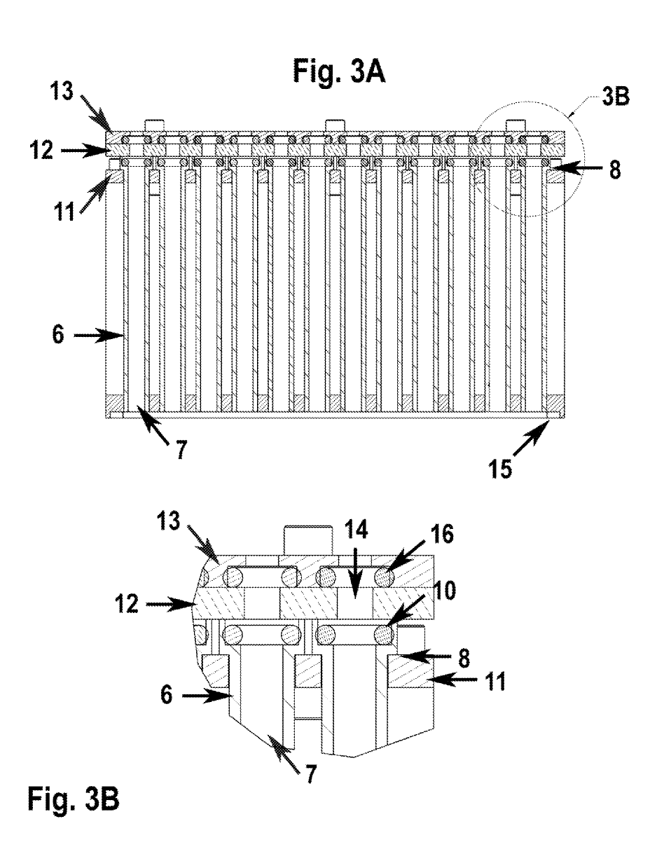

FIG. 3A shows a cutaway side view of a pipette dispense block assembly that has been assembled using the current invention. The pipette block consists of multiple piston chambers 6 with their internal hollow spaces 7 as shown in FIG. 2. The bottom edges of the piston chambers 6 are aligned by placing them on a bottom plate 15, which has a grid of holes into which the piston chambers 6 are placed. The tops of the piston chambers 6 are aligned by placed them on a lower top plate 11 with machined thru-holes. The bottom edges of the piston chamber collars 8 are positioned on top of the top edge of the lower top plate 11 allowing the grid of piston chambers 6 to be held in position. A middle top plate 12 is placed on top of the lower top plate 11 and a third upper top plate 13 is placed on top of the middle top plate 12. FIG. 3B shows a close-up view of the upper assembly of the piston chambers. A lower o-ring 10 is placed inside the collar opening 8 of the piston chamber 6. The third top plate 13 has a similar opening machined into its lower part, which is used for the placement of an upper o-ring 16. This arrangement creates a sealed chamber between the lower o-ring 10 and the upper o-ring 16 which is used to contain lubricant for the piston as required to maintain an optimal airtight seal as required for optimal pipetting results and as used in the prior art (U.S. Pat. No. 6,258,324).

FIG. 4 is a perspective view showing the assembly of individual and separate piston chambers combined together and attached in order to form a multichannel pipette dispense block. A plurality of the molded piston chambers 6 is assembled into a grid of 96 in an 8×12 array. This is a typical grid layout used in the field for multichannel pipetting. This embodiment of the invention represents only one possible layout for the individual piston chambers 6 to form a pipette dispensing block. The present invention is designed and intended to be flexible in comparison to the prior art in order to allow the assembly of the individual piston chambers into any desired grid or single line array and it is recognized that these additional variations of the present invention may be devised without departing from the inventive concept. The individual piston chambers 6 are assembled together by placing them on a bottom plate 15. The upper parts of the piston chambers 6 are attached to the lower top plate 11. The lower top plate 11, middle top plate 12, and upper top plate 13 are attached together as described in FIGS. 3A and 3B. A series of cylindrical posts 17 are used to provide rigid stability to the entire structure of the pipette block assembly. The use of the cylindrical posts 17 represents only one possible method for providing structural rigidity to the pipette block assembly. Other methods such as rigid plates, latticework, or any other similar design could be used to assemble the piston chambers 6 of the invention without departing from the inventive concept.

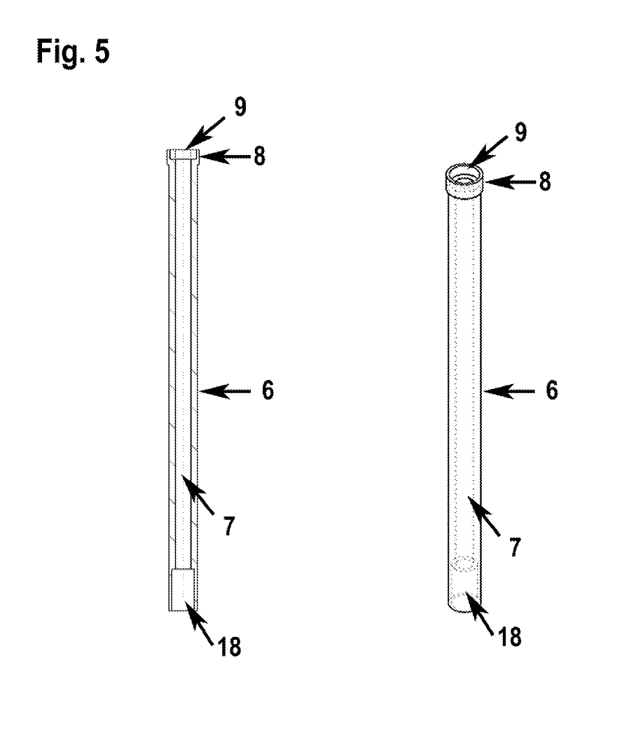

FIG. 5 shows a cutaway side view and perspective view of a second embodiment of the current invention. In this embodiment of the invention, the inner diameter of the piston chamber 6 is smaller, providing a smaller total pipetting volume as required to meet the need for different ranges of liquid dispense volumes. As shown in FIG. 2, the piston chamber 6 is a cylindrical shape which is formed by the injection molding process. The inside of the cylinder is hollow and is the piston chamber 7 within which the piston (not shown) would travel. The piston chamber has a larger diameter collar 8 at the top which provides a mounting point for the piston chamber. The collar 8 also provides a larger internal hollow space 9 at the top of the piston chamber which is used for the placement of a sealing o-ring (not shown) In this second embodiment of the invention, the bottom portion of the molded piston chamber 6 has an expanded internal area 18 which is used for the placement of a sealing material (not shown) on the bottom of the piston chamber (6). This seal is necessary to produce an airtight seal at the bottom of the piston chamber. The described invention of the individual molded piston chamber applies to different variations of shape and size for the internal structure of the piston chamber, and these variations can be applied without departing from the inventive concept.

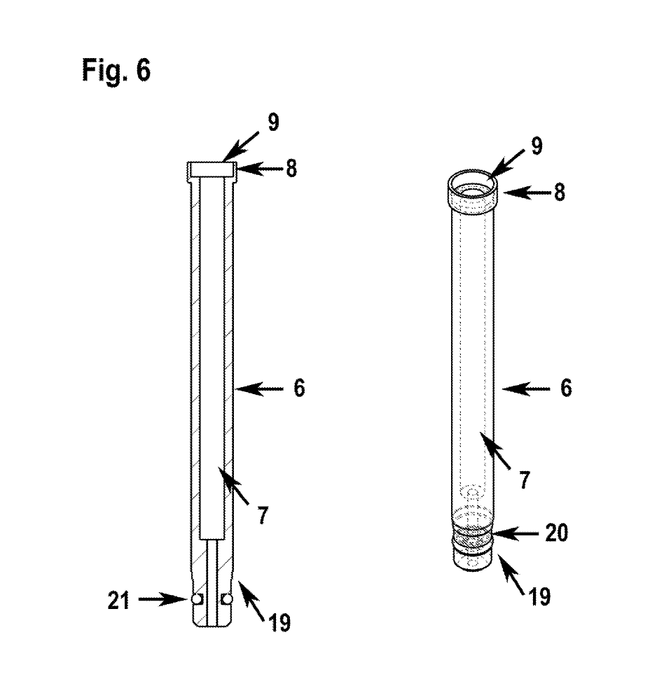

FIG. 6 shows a cutaway side view and perspective view of a third embodiment of the current invention. In this embodiment of the invention, the bottom portion of the molded piston chamber is formed into a different shape in order to accommodate fitting of disposable pipette tips as is common in the current art. As shown in FIG. 2, the piston chamber 6 is a cylindrical shape which is formed by the injection molding process. The inside of the cylinder is hollow and is the piston chamber 7 within which the piston (not shown) would travel. The piston chamber has a larger diameter collar 8 at the top which provides a mounting point for the piston chamber. The collar 8 also provides a larger internal hollow space 9 at the top of the piston chamber which is used for the placement of a sealing o-ring (not shown) In this third embodiment of the invention, the bottom portion of the molded piston chamber forms a reducing shape commonly called a bullet 19. In the lower part of the bullet 19 a groove 20 is molded which allows an o-ring 21 to be fitted. The combination of the bullet 19 and o-ring 21 allow an external pipette tip to be installed onto the molded piston chamber 6. The described invention of the individual molded piston chamber applies to different variations of shape and size for the internal structure of the piston chamber, and these variations can be applied without departing from the inventive concept.

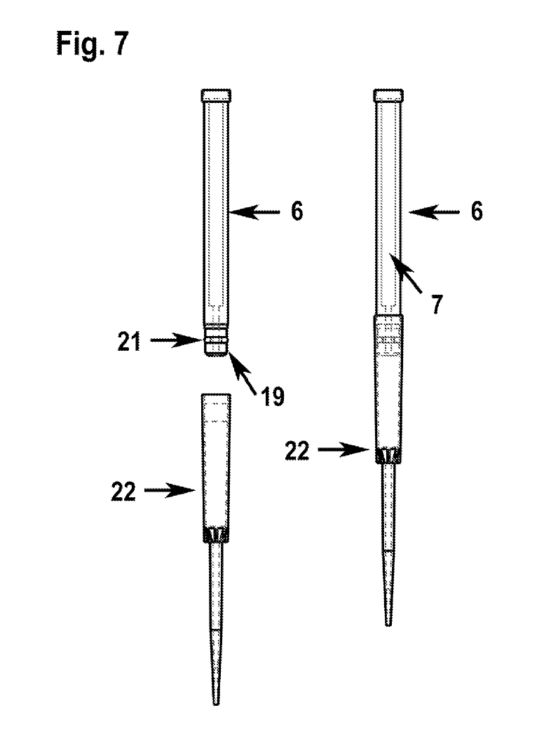

FIG. 7 shows a cutaway side view and perspective view of the third embodiment of the invention as described in FIG. 6 and illustrates how the design of the third embodiment of the invention is used to provide a sealing location for an externally-sealed pipette tip 22. The molded piston chamber 6 is lowered to the pipette tip 22, and the bullet 19 fits into the upper cavity of the pipette tip 22. The o-ring 21 provides an air-tight seal between the hollow pipette tip 22 and the hollow internal chamber 7 of the molded piston chamber 6. This air-tight seal is required in order to maintain proper and optimal pipetting performance.

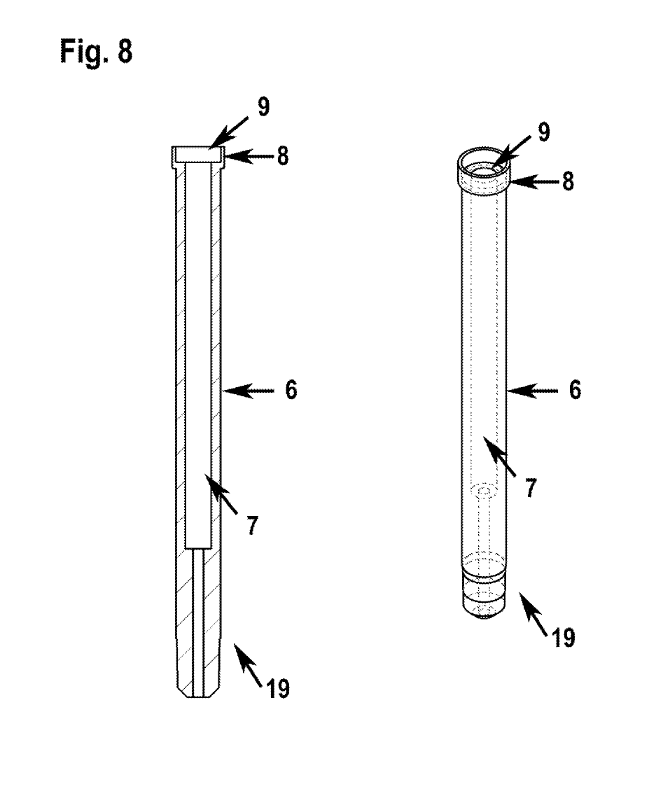

FIG. 8 shows a cutaway side view and perspective view of a fourth embodiment of the current invention. In this fourth embodiment of the invention, the bottom portion of the molded piston chamber is formed into a different shape in order to accommodate fitting of disposable pipette tips as is common in the current art, in a similar manner to the third embodiment of the invention described in FIG. 6 and FIG. 7. In this fourth embodiment of the invention, the bottom portion of the molded piston chamber forms a reducing shape commonly called a bullet 19. This reducing shape of the bullet 19 is used with externally sealed pipette tips that do not require an o-ring in order to create an airtight seal. Instead, a seal is created due to the tight fit and concurrent slight deformation of the pipette tip to the bullet 19 as is common in the current art. The described invention of the individual molded piston chamber applies to different variations of shape and size for the internal structure of the piston chamber, and these variations can be applied without departing from the inventive concept.

After describing the invention, these claims are made:

1. An individual piston chamber in the form of a cylindrical hollow tube which is produced by the injection molding process.

2. An upper collar on the piston chamber of claim 1 that provides a mounting point for the piston chamber and also provides a location for the placement of a sealing O-ring.

3. An assembly of the individual piston chambers of claim 1 into a grid or single line array of any desired number and layout.

4. A rigid structure for the assembly of the individual piston chambers of claim 1 using a combination of rigid plates or posts.

5. The shape of the individual piston chamber is varied to allow compatibility with various types of pipette tips.
